(19) United States
(12) Patent Application Publication
(10) Pub. No.: US 2009/0162490 A1
(43) Pub. Date: Jun. 25, 2009

(54) CALCIUM-FORTIFIED BEVERAGES AND METHOD OF MAKING THEREOF

(75) Inventors: Teodoro Rivera, Algonquin, IL (US); Nicholas Shields, Carpentersville, IL (US); Jason Douglass-Mickey, McHenry, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: Tropicana Products, Inc., Bradenton, FL (US)

(21) Appl. No.: 11/961,689

(22) Filed: Dec. 20, 2007

(51) Int. Cl. A23L 2/02; A23L 1/303; A23L 2/52

(52) U.S. Cl. 426/73; 426/74; 426/590; 426/599

(57) ABSTRACT

A calcium-fortified beverage and method of making the beverage is provided. A calcium source is included that provides about 40% to about 65% of the calcium from calcium lactate and about 35% to about 60% of the calcium is provided from hydroxyapatite. A component may be included for at least substantially masking the aftertaste of the calcium source.

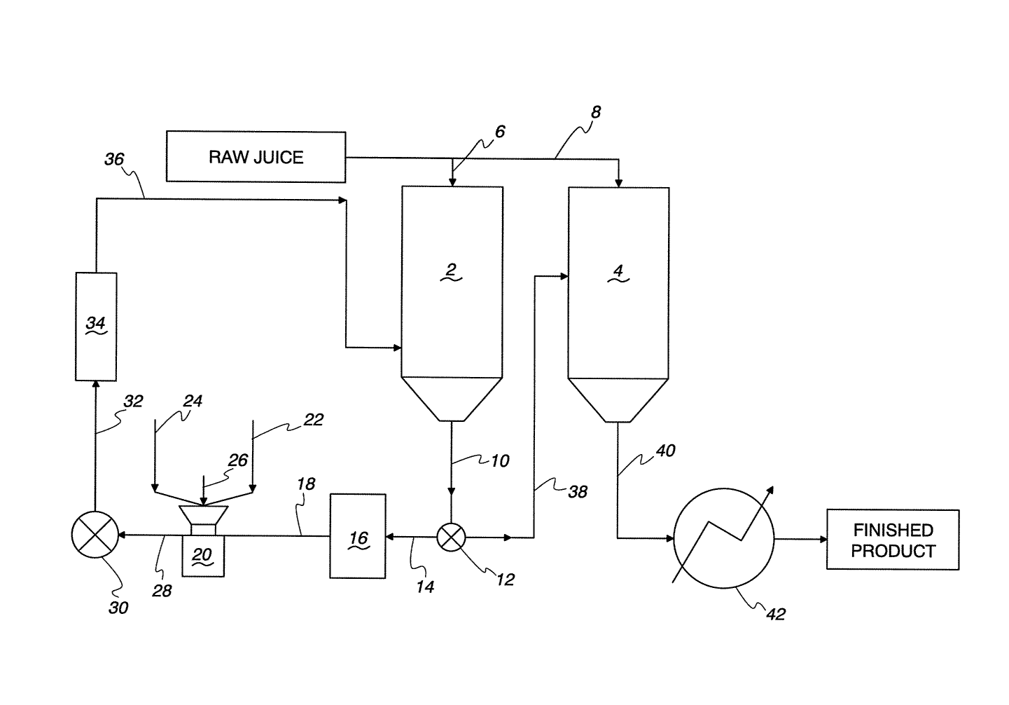

### TECHNICAL FIELD

The invention relates to calcium-fortified beverages and a method of making. More particularly, the present invention relates to a commercially economical method of fortifying beverages with calcium and to the resulting beverage which has good organoleptic properties, despite the presence of added calcium.

### BACKGROUND OF THE INVENTION

A known commercially successful way to fortify beverages is to add calcium citrate malate. However, adding calcium citrate malate adds operational complexity and operational costs. For example, calcium citrate malate readily precipitates during pasteurization resulting in equipment scaling, thereby increasing beverage processing costs. Therefore, there is a need for alternative calcium sources that do not cause processing issues.

Other calcium sources for beverages are known in the art. However, such fortification systems generally have taste drawbacks. For example, calcium chloride gives a salty aftertaste. Calcium hydroxide and calcium oxide neutralize acids in beverages resulting in flat tasting beverages. Calcium lactate has a bitter aftertaste. Tricalcium phosphate has a metallic aftertaste. Calcium sulfate has a very dry aftertaste. Thus, there is a need for a calcium-fortified beverage that does not have a significant taste drawback.

In addition, some calcium sources are sparingly or moderately soluble, making use in beverages difficult or impractical. Calcium citrate is sparingly soluble at nutritionally significant levels. In beverages, moderately and sparingly soluble calcium sources may cause grittiness or cause a milky cloudiness, both of which generally are not considered desirable by consumers and thus cannot be used to provide soluble or dissolved calcium. In addition, the amount of calcium provided by a beverage having a sparingly soluble calcium source may vary significantly from one package to the next and even from one serving to the next within a package.

There is a need for calcium sources for beverages that are less expensive and for a resulting beverage that does not have taste drawbacks as a result of the presence of calcium.

A need also exists for a calcium-fortified beverage that does not require the presence of added citric acid or a citrate compound.

### SUMMARY OF THE INVENTION

In accordance with the present invention, a calcium-fortified beverage is provided that has good taste. It has been discovered that the combination of calcium lactate and hydroxyapatite in particular amounts has a surprisingly good taste, that is, the absence of a significant negative taste attribute as a result of the calcium source. In one aspect of the invention, the calcium-fortified beverage comprises a calcium source present to provide a nutritionally significant amount of calcium, wherein the calcium comprises from about 40% to about 65% calcium lactate and from about 35% to about 60% tricalcium phosphate, preferably hydroxyapatite, all on the basis of calcium contributed by these calcium sources.

The beverage can be any type of beverage but preferably the beverage is a juice beverage. Suitable juices may include citrus juices such as orange juice and non-citrus fruit and/or vegetable juices including, for example, apple, pear, grape, pineapple, strawberry, tangerine, grapefruit, banana, blueberry, cranberry, pomegranate, raspberry, tomato, carrot and celery.

In accordance with another aspect of the invention, the beverage further comprises vitamin D, typically selected from the group consisting of vitamin D₂, vitamin D₃ and mixtures thereof. In accordance with another aspect of the invention, the beverage comprises at least 80 I.U. of vitamin D per 240 ml of beverage.

In accordance with another aspect of the invention, the beverage comprises from about 250 mg to about 450 mg of calcium per 240 ml of beverage.

In still another aspect of the invention, the beverage is a 100% not-from-concentrate juice exclusive of any added vitamins and/or minerals. The beverage may further comprise a topnote flavor component in an amount sufficient to at least substantially mask the aftertaste of the calcium source. The topnote flavor component may be obtained from fruit and typically may comprise from about 0.001% to about 0.5% and more particularly from about 0.001% to about 0.1%, all by weight of the total beverage composition.

In accordance with still another aspect of the invention, a method of making a beverage is provided having a bioavailable source of calcium. The method comprises providing a nutritionally significant amount of calcium, the calcium being from a calcium source such that from about 40% to about 65% of the calcium is from calcium lactate and about 35% to about 60% of the calcium source is from hydroxyapatite. The method further includes dissolving the calcium source in liquid, providing a topnote flavor component in an amount sufficient to at least partially mask off-taste from the calcium source, dispersing the topnote flavor component in the beverage and completing preparation of a finished, ready-to-drink beverage.

### BRIEF DESCRIPTION OF THE DRAWINGS

The FIGURE is a process flow diagram illustrating a method of making a beverage in accordance with the invention.

### DETAILED DESCRIPTION OF THE INVENTION

In accordance with the present invention, a calcium-fortified beverage is provided. The beverage can be any type of beverage. A preferred beverage is a juice beverage. Suitable juices may include citrus juices such as orange juice and non-citrus juices such as apple juice. Preferably the beverage is a juice drink or a 100% juice product. As one of skill in the art would understand, a 100% juice product meets USDA requirements. Such requirements include a minimum brix and specific ratios of brix to acidity. A 100% juice product may include varying amounts of different juice components. For example, some 100% juice products include pulp while others exclude pulp. Typically, orange juice should have a brix of at least about 11.8. Preferred 100% juice products are not from concentrate.

The calcium source for fortifying the juice is such that from about 40% to about 65% of the calcium is from calcium lactate and from about 35% to about 60% of the calcium is from hydroxyapatite. Calcium lactate added by itself to a beverage causes a bitter aftertaste. Tricalcium phosphate, including hydroxyapatite added by itself to a beverage causes a metallic aftertaste. Surprisingly, although both calcium lactate and tricalcium phosphate each have taste drawbacks, it has been found that their combination in the relative amounts disclosed does not have a significant taste drawback.

For clarity, calcium source does not include the calcium that is naturally endogenous to juice. Also, hydroxyapatite is often known as tricalcium phosphate. However, technically hydroxyapatite is not the same as tricalcium phosphate. Hydroxyapatite is a naturally occurring mineral having the approximate formula of 10CaO.3 P₂O₅.H₂O or Ca₁₀(PO₄)₆(OH)₂ having a crystal unit cell comprising two molecules, while tricalcium phosphate has the formula Ca₃(PO₄)₂.

The calcium in the fortified beverage is in a nutritionally significant amount, not less than 100 mg per 240 ml serving. Preferably, the beverage provides at least about 180 mg of calcium per 240 ml serving. More preferably, the beverage provides from about 250 mg to about 500 mg of calcium per 240 ml serving. Still more preferably, the beverage provides from about 300 mg to about 400 mg of calcium per 240 ml serving or even from about 325 mg to about 375 mg or 350 mg of calcium per 240 ml serving.

The flavor of the calcium-fortified beverage may be further improved by adding a topnote flavor component to mask any subtle off tastes from the calcium source. As used herein, topnote flavor is the predominant initial flavor that is detected when the product is tasted or consumed. Thus, the applicable topnote for a particular product will depend on the product. For orange juice, the topnote is orange citrus flavor. For orange juice, any suitable orange citrus flavor topnote flavor can be used. Such topnote flavors are commercially available from various companies, including Firmenich SA of Geneva, Switzerland, for example. The topnote flavor component can provide a fresh, juicy, raw and natural orange juice taste. When the beverage includes juice, the topnote flavor is derived or extracted from the same fruit or vegetable as the juice and thus can consist of natural flavors. Alternatively, the topnote can consist in whole or in part of artificial flavors. Typically, the amount of topnote flavor will be in the range of from about 0.0001% to about 0.5%, more typically from about 0.0001 to about 0.1%, and more typically from about 0.0001% to about 0.008%, all by weight of the total composition and even more typically in the range of from about 0.001% to about 0.004% by weight of the total composition.

In addition, the beverage preferably may be supplemented with vitamin D. Preferably, vitamin D₂, vitamin D₃ or mixtures thereof are used to supplement the beverage with vitamin D. The beverage may provide 50 I.U. or more of vitamin D per 240 ml serving. In one embodiment, the beverage provides at least about 80 I.U. of vitamin D per 240 ml serving.

In addition, the beverage may be supplemented with various nutraceuticals as desired. Suitable mineral nutraceuticals include magnesium and selenium. Suitable vitamin nutraceuticals include vitamins A, B₁, B₂, B₃, B₆, C, and E. Other suitable nutraceuticals include omega-3 fatty acids, glucosamine and fiber.

Other suitable nutraceuticals include aminosugars such as glucosamine and n-acetyl glucosamine. The glucosamine can be in any suitable form. Some suitable forms of glucosamine include glucosamine sulphate, glucosamine sulphate sodium, glucosamine sulphate potassium, glucosamine hydrochloride, glucosamine hydroiodide, glucosamine acetate, glucosamine citrate, glucosamine dodecanoate, and glucosamine malate. Glucosamine may be derived from shellfish, but can also be produced by fermentation (e.g., fungal or microbial), or enzyme reactions (e.g., of fructose and glutamine) as is well known in the art. A typical amount of aminosugar is from about 0.15 wt % to about 0.55 wt %, more typically from about 0.20 wt % to about 0.40 wt %. Glucosamine may be used alone or in combination with other nutraceuticals that may be present in the compositions and methods of the invention, such as collagen, chondroitin, MSM (methyl-sulfonyl-methane), hyaluronic acid, lycopene, linoleic acid, ascorbic acid and their salts.

Preferably, the beverage is 100% juice apart from the presence of added vitamins, nutraceuticals or other adjuvants.

In an alternate embodiment, the beverage is a juice product having substantially less than 100% juice. Preferably the juice product has about 5% to about 55% juice. The juice product may be sweetened with any suitable nutritive sweeteners and/or high intensity sweeteners for the juice product. Such sweeteners are well known in the art and non-limiting examples of suitable nutritive sweeteners include sucrose, fructose, glucose, maltose, or combinations thereof. Non-limiting examples of suitable high-intensity sweeteners include acesulfame potassium (commonly known as acesulfame K or Ace K), sucralose, stevia extract, lo han guo, monatin, and rebaudioside A. The juice product may also have artificial and natural flavors as desired.

The process of making a juice beverage in accordance with the invention will be described with reference to the FIGURE. A source of raw juice is placed into holding tanks 2 and 4 via suitable delivery piping 6 and 8. Juice can be removed from holding tank 2 via a line 10, through valve 12 where the juice is directed through a line 14 and into a surge tank 16. From surge tank 16, the juice is directed through a line 18 and into shear mixing/dispensing device 20. Mixing device 20 is suitable for mixing solids into liquids and/or liquids into liquids depending on the material being added. Suitable mixers for this purpose are well known in the art and include, for example, mixers sold under the trade designation “TPM +” by APV of Lake Mills, Wis., and the “CMS2000” by IKA Works of Wilmington, N.C. Into mixing device 20 dry calcium lactate is introduced via a line 22 and dry hydroxyapatite is introduced via a line 24. The introduction of hydroxyapatite and calcium lactate may be simultaneous or sequential. Alternatively, the calcium lactate and hydroxyapatite can be preblended and then introduced as in the preblended form. The addition to the orange juice can be done on a continuous basis. The calcium lactate powder of line 22 may be introduced at a rate of from about 0.5 lb/gal to about 1.0 lb/gal, and preferably from about 0.6 lb/gal to about 0.9 lb/gal. For example, the hydroxyapatite of line 24 may be introduced at any desired rate, such as, for example, from about 0.2 lb/gal to about 0.6 lb/gal, and preferably from about 0.25 lb/gal to about 0.45 lb/gal with the orange juice of line 18 at a flow rate of about 90-100 gallons/minute or greater as desired and as permitted by the equipment being utilized. In addition, the beverages of the invention may also be supplemented with an adjuvant as desired which may be a vitamin, particularly vitamin D, or a nutraceutical which could be a vitamin nutraceutical, for example. Typically, the adjuvant stream, which in this particular case is a vitamin D liquid stream 26, is dispersed in the juice by shear mixer/dispenser 20 and shear mixer 30 as shown in the FIGURE. The adjuvant in stream 26 may include the topnote and any other desired additives. The adjuvant may include vitamin D and/or any desired nutraceutical(s) and the topnote in stream 26. The adjuvant or any portion thereof, including vitamin D and the topnote can be added before, during, but typically after the addition of calcium to the juice.

The combined mixed materials from mixer 20 are fed via a line 28 into an inline high shear mixer 30 to further disperse and dissolve the materials added to the juice in mixer 20. Suitable high shear mixers are well known in the art and include those sold by Silverson in East Longmeadow, Mass. or DR2000 from IKA Works of Wilmington, N.C.

Next, the resulting mixture stream from high shear mixer 30 is directed via a line 32 to a chiller 34 and then directed via a holding line 36 to tank 2. The juice in process tank 2 is recirculated to tank 16 and the process continues until the desired amounts of calcium lactate, hydroxyapatite and adjuvant(s) are achieved.

The above-described process for adding calcium lactate and hydroxyapatite may be stopped when the concentration of calcium and any desired adjuvants in the juice in tank 2 meets the desired concentration in the final product.

Alternatively, the process may continue so that the level of calcium in the juice in tank 2 exceeds that desired in the final product by any desired amount, which could be, for example, by a factor of 2, 3, 4, 5 or even greater. The juice in tank 2 can then be diluted with juice in tank 4 to achieve the desired final concentration by delivering the juice in tank 2 through valve 12 and a line 38 to tank 4.

The method of the invention allows the calcium adding, mixing and dispersion/solubilization time to be reduced by half relative to the prior art method of adding citric acid, malic acid and calcium hydroxide using the same equipment according to pilot data. One reason for this is that the addition of calcium hydroxide in powder mixer 20 has to be relatively slow so as not to cause large pH changes in line 28 and to reduce the temperature rise in line 28, both of which can cause undesirable flavors and improper calcium reaction and/or unwanted insoluble calcium formation.

Once the desired concentration of calcium is achieved, the single-strength juice is taken from tank 4 via a line 40 to heat exchanger 42 for pasteurization. The resulting pasteurized juice can then be packaged, shipped in bulk, or stored for later use. Pilot data indicates that the calcium source of the invention causes less scaling in heat exchanger 42 than the prior calcium source of calcium citrate malate. Improved process efficiency is another reason why the calcium source of the invention has unexpected advantages to prior art calcium sources.

Preferred particle size distribution for the hydroxyapatite and tricalcium phosphate when added to the beverage is less than or equal to about 0.5% retained by 140 mesh and less than or equal to about 5% retained by 325 mesh, all wet sieving, and more preferably 0.06% retained by 140 mesh and 2% retained by 325 mesh.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

1. A calcium-fortified beverage having a good taste comprising
a calcium source present to provide a nutritionally significant amount of calcium, the calcium being from a calcium source such that about 40% to about 65% of the calcium is from calcium lactate and from about 35% to about 60% of the calcium is from hydroxyapatite.

2. The beverage of claim 1 further comprising vitamin D.

3. The beverage of claim 2 wherein the vitamin D is selected from the group consisting of vitamin D₂, vitamin D₃ and mixtures thereof.

4. The beverage of claim 3 wherein the beverage provides at least about 80 I.U. of vitamin D per 240 ml serving.

5. The beverage of claim 4 wherein the beverage provides at least about 180 mg of calcium per 240 ml serving.

6. The beverage of claim 1 wherein the beverage provides from about 250 mg to about 450 mg of calcium per 240 ml serving.

7. The beverage of claim 1 further comprising a citrus juice.

8. The beverage of claim 7 wherein the citrus juice is not from concentrate.

9. The beverage of claim 1 wherein the beverage is a 100% not-from-concentrate juice exclusive of any added vitamins and minerals.

10. The beverage of claim 1 further comprising a topnote flavor component in an amount sufficient to at least substantially mask the aftertaste of the calcium source.

11. The beverage of claim 1 wherein the topnote flavor component is obtained from fruit.

12. The beverage of claim 11 wherein the beverage comprises from about 0.001 wt % to about 0.5 wt % of the topnote flavor component.

13. The beverage of claim 11 wherein the beverage comprises from about 0.001 wt % to about 0.1 wt % of the topnote flavor component.

14. The beverage of claim 12 wherein the beverage is a 100% not-from-concentrate juice.

15. The beverage of claim 1 further comprising a nutraceutical.

16. The beverage of claim 15 wherein the nutraceutical is selected from nutraceutical vitamins, omega-3-fatty acids, aminosugars and fiber.

17. The beverage of claim 15 wherein the nutraceutical is selected from glucosamine, collagen, chondroitin, methyl-sulfonyl-methane, hyaluronic acid, lycopene, linoleic acid and combinations thereof.

18. A method of making a beverage having a bioavailable source of calcium comprising:
providing a nutritionally significant amount of calcium, the calcium being from a calcium source such that about 40% to about 65% of the calcium is from calcium lactate and from about 35% to about 60% of the calcium is from hydroxyapatite;
dissolving the calcium source in a liquid;
providing a topnote flavor component in an amount sufficient to mask off-taste from the calcium source;
dispersing the topnote flavor component in the beverage; and
forming a finished ready-to-drink beverage.

19. The method of claim 18 further comprising providing a source of vitamin D selected from the group consisting of vitamin D₂, vitamin D₃, and mixtures thereof in an amount so that the finished beverage provides at least 50 I.U. of vitamin D per 240 ml serving and dispersing the vitamin D in the beverage.

20. The method of claim 18 wherein the beverage is orange juice.

21. The method of claim 18 wherein the beverage is a juice.

22. The method of claim 18 further comprising providing a nutraceutical and dispersing the nutraceutical in the beverage.
